(19) United States
(12) Patent Application Publication
(10) Pub. No.: US 2025/0020766 A1
(43) Pub. Date: Jan. 16, 2025

(54) SPARSE MIMO PHASED ARRAY IMAGING RADAR

(71) Applicant: BDCM A2 LLC, Dover, DE (US)

(72) Inventor: Kenneth Ray CARROLL, Carlsbad, CA (US)

(21) Appl. No.: 18/708,574

(22) PCT Filed: Oct. 25, 2022
(86) PCT No.: PCT/US2022/047740

§ 371 Date: May 8, 2024

Related U.S. Application Data
(60) Provisional application No. 63/271,376, filed on Oct. 25, 2021.

(51) Int. Cl. G01S 7/03; G01S 13/02; G01S 13/44; G01S 13/89; H01Q 3/36

(52) U.S. Cl. CPC G01S 7/032; G01S 13/89; H01Q 3/36; G01S 2013/0263; G01S 13/4409

(57) ABSTRACT

High-performance 4-D Sparse MEMO Phased Array imaging and object detection radars with substantially reduced hardware and processing specifications are presented for automotive, ariel, and other application spaces. The radar antennas have 2-D angular sparse array and MIMO (Multiple Input and Multiple Output) features that can be implemented with a variety of subarrays or Antenna in Packages (AiPs) greatly simplifying the system manufacturing and feasibility. The significantly reduced data processing requirements also become feasible with the sparse subarray architectures. Advanced signal processing algorithms are presented, when coupled with the sparse and MIMO features, allow improved 2-D angular resolution of objects, improved imaging, and low sidelobes allowing the resolution of weaker targets in the presence of stronger target reflections.

### CLAIM OF PRIORITY

This application claims priority from U.S. Provisional Application No. 63/271,376, titled “Sparse MiMO Phased Array Imaging Radar,” filed on Oct. 25, 2021, and incorporated herein by reference in its entirety.

### BACKGROUND

Imaging radar systems for automotive applications have many challenging and often conflicting requirements. Consequently, these applications result in difficult choices between high resolution, long range, fast update rates, low hardware complexity, size dimensions, low power, and cost. Phased arrays for example can meet long ranges by focusing the energy into pencil beams but has limitations in covering the desired field of view (FoV or FOV) in a reasonable time. Radars relying on multiple input-multiple output (MIMO) techniques have improved angular resolution and fast update rates, however since the transmit antenna radiates power over a wide FoV, the detection range of small RCS targets such as pedestrians is limited. For current radar technology, improved angular resolution of targets requires increased aperture size which leads to increased hardware complexity cost, processing, and power consumption.

### BRIEF DESCRIPTION OF THE DRAWINGS

The present application may be more fully appreciated in connection with the following detailed description taken in conjunction with the accompanying drawings, which are not drawn to scale and in which like reference characters refer to like parts throughout, and wherein:

FIG. 1 illustrates a part of a radar system packaged in an antenna in package (AiP or AIP) structure, according to example embodiments of the present inventions and subject technology;

FIG. 2 illustrates various antenna arrays and subarrays, according to example embodiments of the present inventions and subject technology;

FIG. 3 illustrates a progression from a full array of elements to a sparse array configuration, then to positioning subarrays and finally to a virtual SMPA with MIMO capability, according to example embodiments of the present inventions and subject technology;

FIG. 4 illustrates an example of an SMPA radar configuration, according to example embodiments of the present inventions and subject technology;

FIGS. 5A, 5B and 5C illustrate array designs based on compact uniform linear array (ULA) and minimum redundancy array (MRA) sparse array features as well as the associated array responses, according to example embodiments of the present inventions and subject technology;

FIG. 6 illustrates an example process for designing a sparse array as in FIG. 5A with various MIMO aspects as in a SPMA radar for 2-D Angle of Arrival (AoA) target location detection, according to example embodiments of the present inventions and subject technology;

FIGS. 7A and 7B illustrate an example of a staircase configuration sparse array, referred to herein as “Staircase-A,” and plots of the antenna response of the SPMA radar, according to example embodiments of the present inventions and subject technology,

FIGS. 8A and 8B illustrate an example of an SPMA radar in a staircase sparse array configuration having MIMO design aspects, according to example embodiments of the present inventions and subject technology;

FIGS. 9A and 9B illustrate an example of an SPMA in a Staircase-A configuration and multiple transmit arrays distributed in azimuth and elevation to provide corresponding virtual arrays for improved azimuth and elevation resolution and plots of the array peak sidelobe level (PSLL), according to example embodiments of the present inventions and subject technology;

FIGS. 10A and 10B illustrate examples of the SPMA radar in a Staircase-B configuration with multiple transmit arrays uniformly spaced and plots illustrating object detections and the resultant impact on the angular sidelobes according to example embodiments of the present inventions and subject technology;

FIGS. 11A and 11B illustrate an example of SPMA radar incorporating ULA subarrays proximate a transmit array, and plots of the array response for detection of close targets, according to example embodiments of the present inventions and subject technology;

FIGS. 12A and 12B illustrate an example of an SPMA radar with random placement of the subarrays and plots of the resultant redundancy and of the array response for target detection, according to example embodiments of the present inventions and subject technology;

FIG. 13 illustrates an Iterative Adaptive Algorithm (IAA) method to process radar signals received by an SMPA radar as described herein, according to example embodiments of the present inventions and subject technology;

FIG. 14 illustrates an aerial application for use of an antenna array using an SMPA radar, according to example embodiments of the present inventions and subject technology; and

FIG. 15 illustrates a radar architecture incorporating SMPA techniques, according to example embodiments of the present inventions and subject technology.

### DETAILED DESCRIPTION

The present invention provides methods and apparatuses for imaging and object detection radars having subarray antenna arrays arranged in a sparse array and MIMO configurations that improves sensor performance. This class of radars in the following is referred to as a Sparse MIMO Phased Array (SMPA) radar. To realize the object detection and imaging capabilities with the sparse array features, the invention implements advanced algorithms, such as detailed below.

As presented herein, a high performance four-dimensional (4-D) imaging and object detection radars are achieved that minimize requirement trade-offs using an SMPA radar. Hardware and processing complexity are reduced using sparse array features. Subarrays realized with antenna in packages (AIPs) reduce the manufacturing complexity and achieve longer ranges for small RCS targets and the MIMO features improve the 2-D angular resolution and accuracy with a single snapshot of data when coupled with the advanced signal processing that is presented. Angular resolution refers to the ability of the radar to distinguish and separate two targets at a same range same radial velocity relative to the radar. Accuracy refers to conformance of the radar measurements to the physical position, velocity and so forth.

For automotive applications, for example, one desires fast object detection and accurate understanding of the field of view (FoV) to enable real time decision-making, such as braking or taking avoidance action. Examples provided herein are primarily directed to a radar system implementation but are applicable in a variety of applications, scenarios and uses. As a non-automotive application of this invention, an aerial application, such as for drone and unmanned aircraft, landing requires an accurate knowledge of an expanded field of view. The present invention provides this expanded ariel view while reducing the hardware and weight of the antenna and radar unit.

While in the following, we will primarily be referring to radar designs with collocated transmit and receive antennas employing Frequency Modulated Continuous-Wave (FMCW) waveforms, the invention is not limited to collocated antennas or FMCW waveforms. Pulse waveforms, LFM waveforms and others in a collocated, a transmit-receive, or a bistatic architecture are applicable given the proper hardware and processing support. In addition, the following invention is applicable to any MIMO waveforms (e.g. Time Division Multiple Access (TDMA), Doppler Division Multiple Access (DDMA), Code Division Multiple Access (CDMA), Frequency Division Multiple Access (FDMA), Orthogonal-FDMA (OFDMA), and others) that provides sufficient orthogonality between transmit antenna signals.

The examples provided herein of the present inventions are constructed with antenna subarrays. For transmit and receive subarrays, phase shifters at the appropriate elements allow steering of the subarrays and the antenna beams. For the receive subarray, low noise amplifiers (LNA) improve the noise figure of the radar system. For the transmit (Tx) subarray, power amplifiers (PAS) at the appropriate elements improve the effective radiated power (EIRP). Transmit/Receive subarray architectures would of course include both LNAs and PAs as well as the capability to switch between transmit and receive signal paths. A desirable way to realize the subarrays is through packaged structures, referred to as an Antenna in Package (AIP), which position the antenna elements in close proximity to the active elements, namely, LNAs, PAs, and the phase shifters. The benefits of the AiP include lower transmission line loses due to the proximity and simplified manufacturing of the SMPA which consists of multiple AiPs as shown in the examples below. Note that while the active elements provided added capability, they are not necessarily required in the AiPs or subarrays depending on the SMPA design goals.

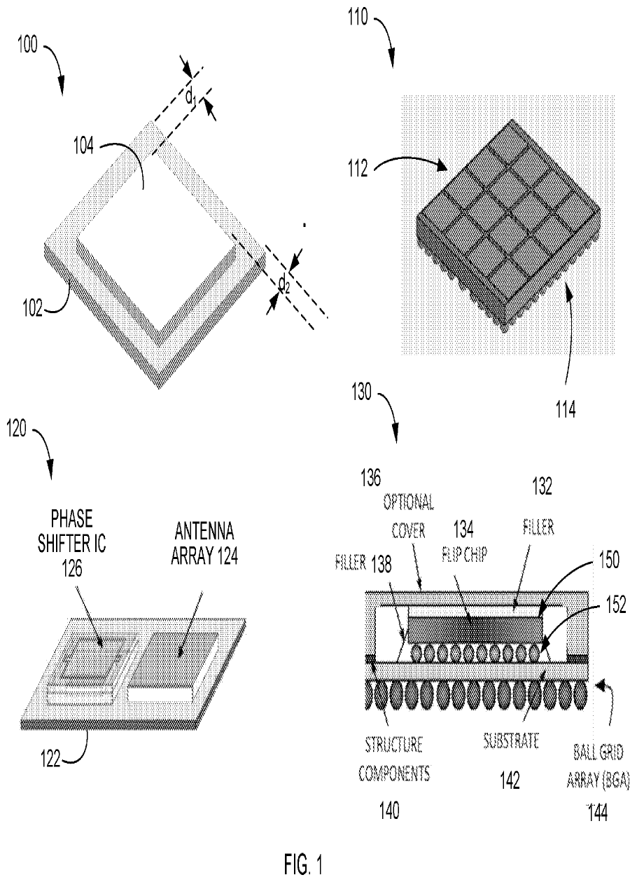

FIG. 1 illustrates a part of a radar system packaged in an antenna in package (AIP) structure 100, according to example embodiments of the present inventions and subject technology. Examples of AIP structures are illustrated having various formations for various applications, size specifications, performance specifications and/or manufacture considerations. Structure 100 provides an antenna element structure 104 on a substrate 102, wherein multiple individual antenna element structures form an antenna array structure. Structure 120 includes an antenna array 124 and a phase shifter integrated circuit (IC) 126 on a substrate 122. The AIP structure 120 is encapsulated as a single unit or component for use in a radar or other electromagnetic device. The AIP 120 integrates radiating antenna elements, an antenna controller and transceiver into a single unit. In a top portion of the AIP 120, 124 the phased-array antenna and 126 the antenna control components enclosed in a package. The controller for beamsteering the antenna array 124 is phase shifter circuit 126. In the present embodiment, the phase shifter circuit 126 is an analog circuit of components, including variable gain amplifier and low noise amplifier, wherein the components are controlled to affect change in the beam direction from the antenna array 124.

Also illustrated in FIG. 1 is AIP 110, having multiple radiating elements forming an antenna array 112 configured in a (4×4) square and positioned on an upper surface of the AIP 110. The spacing between radiating elements 112 is as given in the dimensions of structure 100, d₁ in a first dimension and d₂ in a second dimension. The device 110 is an AIP having connectors on the side opposite the antenna elements 112, which are in the form of a ball grid array 114. The phase shifting circuit (not shown) is within the AIP 110 coupled to the connectors and the antenna array 112.

Device 130 is similar to device 110 and is illustrated from a side perspective view, having a flip chip 134 with antenna array 150 on a top side and phase shifting circuits (not shown) coupled to the antenna array 150 and the connectors 152. The flip chip 134 is enclosed in a package having substrates 142 and cover 136. There are a variety of configurations and structures for AIP designs.

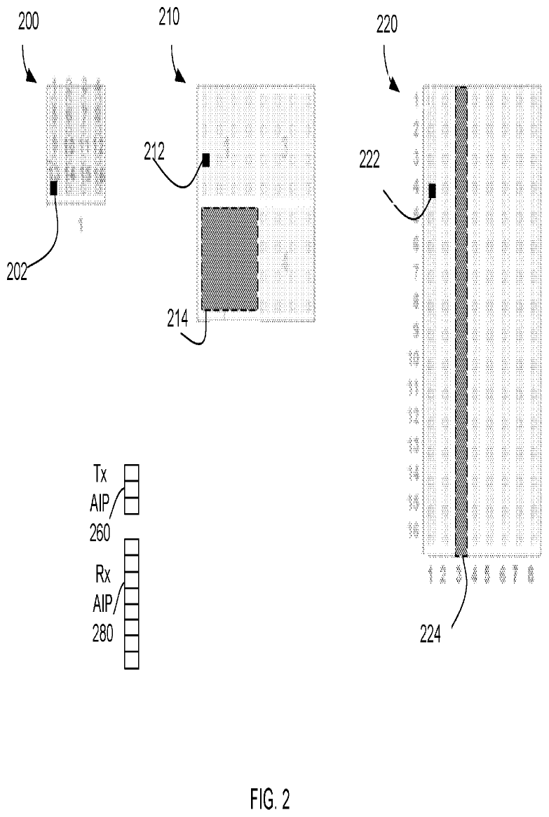

FIG. 2 illustrates various antenna arrays and subarrays, according to example embodiments of the present inventions and subject technology, specifically examples of various configurations of radiating elements forming AiPs/subarrays that can be used to realize an SMPA. AIPs or other package configurations may be used for the SMPA. In a first example, the AIP 200 includes 16 elements, with each element 202 positioned proximate to other elements. The Tx or receive (Rx) AiP 200 configures radiating or signal receiving elements 202 into the shape of a square. The Tx AiP 200 has a radiating or transmitting functionality when it is supplied with radio Frequency (RF) electromagnetic power from an active element, such as a transceiver or PA, which may be further amplified by PAs associated with the AiP before radiating from the elements 202. The Rx AiP 200 has a receiving functionality for RF signals received by the AiP elements, which are then amplified by active elements such as an LNA allowing further signal processing. The AiP 200, which may be an Rx or Tx AiP, is referred to as a (4×4) Tx or Rx subarray based on the number of elements in each dimension and the transmit or receive functionality of the AiP. The dimensions of the AiP defines the aperture of the antenna array of the AiP. For example, consider AiP 210, which has a larger aperture made up of more elements; specifically, AiP 210 is made up of multiple (4×4) AiPs configured in a larger square and is referred to as an (8×8) AiP. The AiP 210 has elements 212 and subarrays 214, which may also be referred to as sub-blocks. Another example of an AiP is a (16×8) array 220 made up of eight subarrays 224 having elements 222. The subarray 224 is a (1×16) array including elements 222. Each configuration and subarray definition determine the aperture and behavior of the antenna array. Similarly, subarrays within AiP 220 or AiP 210 may be defined in different shapes and configurations according to application, such as (2×16) and so forth. The difference in the various configurations and layouts result in different antenna apertures and behavior. In these various configurations, AiPs are configured in uniform patterns, such as rectangular. The present inventions have a reduced number of elements in the arrays, some arrays have uniform patterns and others are non-uniform.

While FIG. 2 provides specific configuration examples, once designed the subarray or blocks may be arranged in various configurations. The AiP provide a modular solution of building blocks that may be placed together to operate as an antenna. This modular approach extends to the phase shifting components as well, which may be configured to accommodate any of a variety of sizes. The flexibility of these designs provides expanded applications with small modification.

For most of the examples, (4×4) subarrays or AiPs are given as examples of basic units of an antenna array, however the invention is not limited to this size and could be smaller, such as smaller arrays of (2×2) or (3×3), or larger arrays, of (5×5) or (8×8) and may be rectangular, such as a. (1×8) or may be arranged in various configurations arranged with spacing to achieve a desired result, depending on the radar/antenna design goals and desired illumination of the FoV. The signal processing to achieve the high 2-D angular resolution discussed below, depends primarily on the phase center locations of the AiPs, where the phase center is defined as the apparent source point of radiation. The AiP size determines the subarray gain and the instantaneous coverage of the FoV. For example, a first (4×4) receive AiP with first phase centers and has a 3 dB beamwidth of ˜25 deg, may be organized as a (2×2) AiP with the same phase centers (or just activating a (2×2) part of the (4×4) AiP) would double the azimuth and elevation beamwidth. The advantage of the smaller size would be that fewer beam steers are required to cover the FoV and improve scan time at the expensive of the subarray antenna gain. Also, while λ/2 spacing is generally assumed between the AiPs elements, other spacings could be used, where A is the wavelength of transmission.

The example SMPA radar designs typically employ eight (8) physical receive AiPs, such as AiP 200, and two (2) or three (3) physical transmit AiPs, such as AiP 200, or subarrays. Additional or fewer receive and transmit AiPs could be used to obtain the desired angular resolution through aperture size or the desired sensitivity through EIRP or antenna gain. There are a variety of configurations and organizations to achieve desired results.

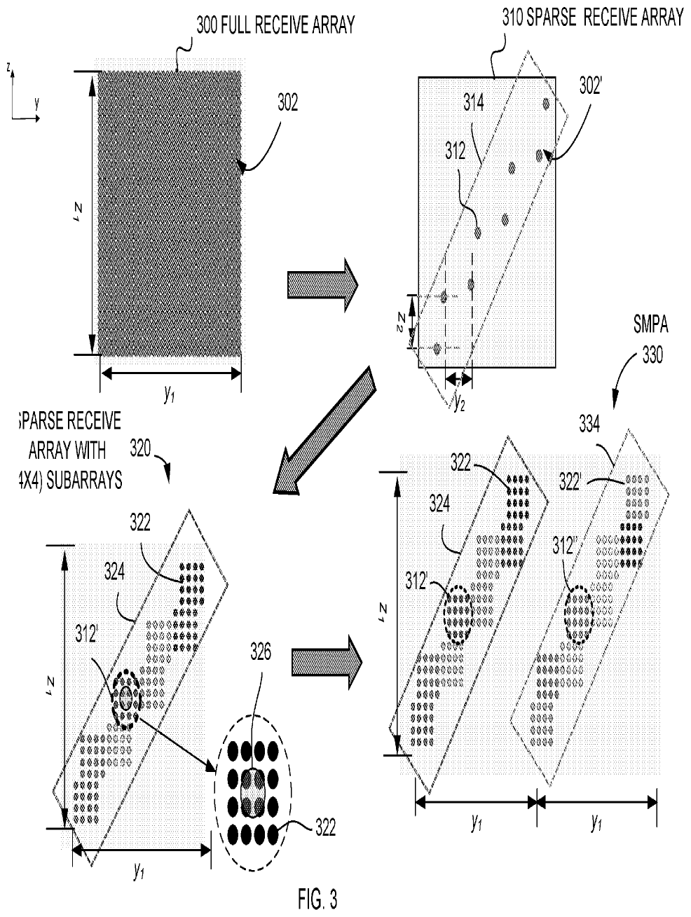

FIG. 3 illustrates a progression from a full array of elements to a sparse array configuration, then to positioning subarrays and finally to a virtual SMPA with MIMO capability, according to example embodiments of the present inventions and subject technology. The present imaging and object detection radar invention can be thought of as evolving or as a progression of steps from a full phased-array, 300, with (32×32) elements 302 as in FIG. 3, which is the receive antenna of a radar system. With over 1000 elements, such as element 302, in the full array 300 (having physical dimensions z₁×y₁) having a corresponding aperture. Within the full receive array 300, each element 302 has a transmission path including phase shifters and low noise amplifiers along the digital channel, and this requires a substantial amount of components and complexity, and therefore, such a system is not always feasible, cost effective or optimum. In addition, the computational requirements for ˜1000 data channels incur substantial computational burden and may not be reasonably feasible for real-time operation. To simplify the full size receive array 300, the design may include subarrays having a reduced capability and performance; however, even with such reduced performance, the complexity is still quite high for a full (32×32) or other large receive array. The (32×32) full receive array 300 in the present applications may be designed to radiate a pencil beam where numerous beam steers are used to cover the FoV corresponding to a low scan rate and/or high computational requirements. A reduction in the number of elements and/or subarrays results in reduced number of beam steering elements for each element and/or subarray. To provide the same radar behavior, angular resolution, and accuracy, while reducing the complexity and computation of the radar, the present inventions provide a virtual array using sparse array techniques.

The present inventions provide a sparse array to replicate the operation of the full receive array 300. The process identifies locations 312 within a same physical dimension as in full receive array 300. A radiating element 302 is positioned at each location 312 forming a subset configuration 314. This is a sparse receive array 310 which avoids many of the phase-lag redundancies present in the full size receive array 300. By using a sparse array configuration, such as sparse receive array 310, the number of elements is reduced from 1000 elements, as in the full receive array 300, to 8 elements in the sparse receive array 310 with corresponding reductions in the beam shift components, such as phase shifters, LNAs, reductions in digital channels and reductions in processing complexity. The sparse signals may be reconstructed from the 8 digital channels using Compressive Sensing, Iterative Adaptive Analysis (IAA) and other high-resolution algorithms presented hereinbelow. SMPA design goals consider the choice elements 302 to include in the 2-D sparse array 310 to obtain a faithful reconstruction to cover the FoV. The chosen elements 302 are represented as elements 302′ and represent phase center locations for placement of subarrays or blocks. The sparse receive array 310 requires the presence of the signal phase lags between the proximate elements 302′ similar to the signal phase-lags in the full receive array 300 between the elements 302. The distance between elements 302 are y₂ and z₂. The full receive array 300 has substantially more redundancy in the signal phase-lags which may be avoided to achieve acceptable 2-D angular resolution performance and side lobe level (SLL) performance with the sparse receive array 310. Note, the sparse array process is applied to the receive array for clarity of understanding.

To further improve the signal power, the present inventions design a sparse receive array 320 by positioning (4×4) AiPs/subarrays 322 at the phase centers identified by elements 302′ of the sparse receive array 310. For example, at location 312 of sparse receive array 310, a (4×4) subarray 312′ is positioned. The receive AiP 312′ couples the LNA signal outputs at each patch element 322 into a single output signal at the phase center of subarray 312′ corresponding to location 312 of an element 302′. The receive beams of the receive antenna array 320 includes 8 subarrays 322 organized at locations as the phase centers in sparse receive array 310. The subarrays 322 are steered to a desired pointing direction to realize the improved antenna gain. Steering in the present inventions may be implemented with phase shifters in an AiP. Additional subarray beam steers may be used to cover the entire FoV. There are a variety of scanning and beam steering patterns that may be used to scan an entire 3-D FoV.

Another method to improve performance is to design MIMO capability to the sparse receive array 320 to enhance the 2-D angular resolution. As MIMO techniques provide signals from each of multiple transmit antenna arrays having discernable waveforms, the receive antenna array aperture is effectively expanded from the physical receive array 320 to include additional virtual arrays such as 334 according to the number of transmit antenna arrays. By appropriate placement of multiple transmit antennas (not shown), the increased aperture of a virtual SMPA 330 is obtained. Extension of the sparse array signal processing achieves the improved 2-D angular target resolution and accuracy. In this case, an additional Tx AiP (not shown) was placed to duplicate each physical receive AiPs 322, in subset configuration 324 that effectively map to subset 334. A subarray 312′ is located at a position of element 312, having 16 elements arranged in a (4×4) square, and the phase center 326 is located at the phase center of element 312. From the transmitter, transmit signaling from multiple physical transmit arrays are provided with signaling differences, such as time, frequency or phase shifts, to identify the Tx AiP origin of each received signal at the SMPA 330. Signals from the multiple transmit arrays are received at the subarrays 322′ as if also received at a virtual subset 334, and so forth. Implementing the MIMO process to allow corresponding virtual receive arrays 334 resulting in an effective doubling of the 8 physical receive arrays 322 with 8 receive virtual arrays 334 to form the larger virtual array, SMPA 330. The phase centers of each of the arrays 322 are the same in the virtual arrays 322′. As illustrated, the effective realizable size or aperture of SMPA 330 is (z1×2y2).

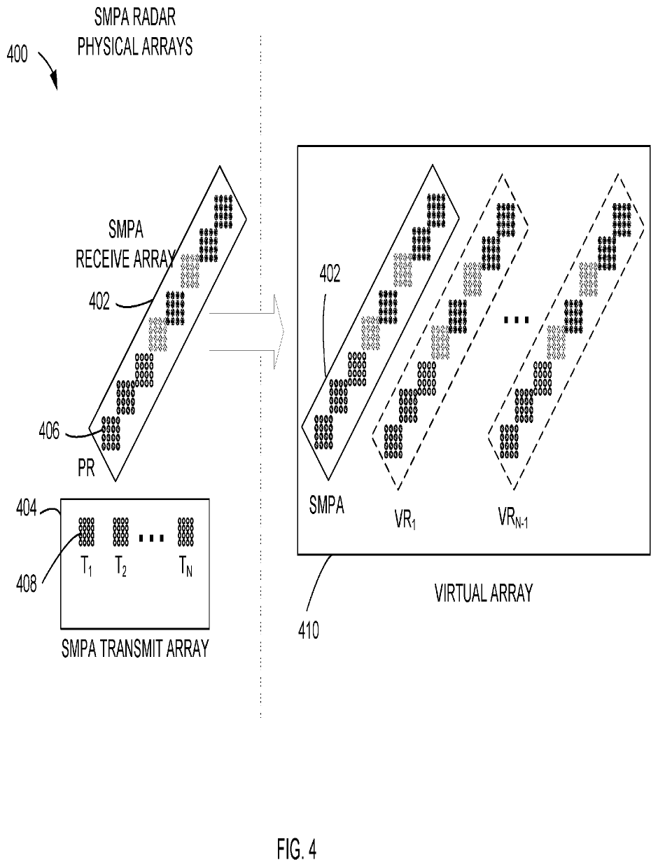

FIG. 4 illustrates an example of an SMPA radar virtual array configuration, according to example embodiments of the present inventions and subject technology, having expanded receive aperture of an SMPA physical receive 402 having 8 subarrays 406 configured in a sparse array format. SMPA 402 is positioned proximate to a transmit array 404. Within the SMPA transmit array 404 are N transmit arrays 408, which in the present inventions are Tx AiPs 408. The SMPA radar physical arrays are illustrated as SMPA receive array 402 and the SMPA transmit array 404, having transmit subarrays T¹, where i=1, 2, . . . . N. This configuration behaves as an SMPA virtual array 410 having a larger aperture than the SMPA physical receive 402, as illustrated where in addition there are (N−1) virtual arrays, identified as VR₁, . . . . VR_{N-1}. In this embodiment, the SMPA physical receive array 402 is a configuration of AiPs or subarrays 406 in a distributed manner. Rather than forming a geometric shape, such as a rectangle in the FIG. 4 examples, the receive array 402 has subarrays 406 are arranged as a stairstep or diagonal pattern. There are a variety of arrangements of receive arrays 402 and transmit AiPs 408 that may be implemented.

To realize the increased virtual sparse array aperture of the present examples, each Tx AiP 408 transmits an orthogonal MIMO waveform such as DDMA, TDMA, and CDMA. With these waveforms, the system may separate the target signal reflections resulting from each MIMO AiP transmitter 408 providing additional spatial information. With the known positions of the transmit and receive arrays, which in these examples are AiPs but may be implemented in other forms, the relative phase centers of each transmit and receive pair are arranged to form the SMPA virtual array 410. With the increased aperture of the SMPA virtual array 410, better angular resolution may be achieved.

Note that an SPMA radar as in FIG. 4 can be configured with the sparse array features of the receive antenna and a single transmitter T₁. In this case, which may be advantageous for some applications, the MIMO virtual array features will not be present which would not increase the virtual aperture size. The native angular resolution of the physical receive antenna with low SLL can be achieved provided the advanced signal processing techniques for the sparse array signals detailed for this invention below are implemented.

Furthermore, an application of the antenna configurations of this invention may only involve the sparse array features of the receive antenna with no transmitters. In this case, the application functions as a receiver module capable of determining the AoA of signal sources external to the receive module. The angular resolution of the physical receive antenna can be achieved provided the advanced signal processing techniques for the sparse array signals detailed for this invention below are implemented.

For most of the SMPA radar designs discussed above and below, the receive subarrays 406 may be thought of as having a signal input from the patch elements in the AiP or subarray. These signals are combined after a phase shifter and LNA into a single output at the AiP phase center. For a (4×4) receive AiP, there are 16 signal inputs from each patch that are eventually combined into a single output. A receive AiP design could also have multiple outputs along with the multiple inputs, not necessarily one input per patch or radiating element, in an SMPA radar design. For the transmit AiPs 408 of the SMPA designs discussed, the situation is essentially reversed with one input signal that is split into multiple signal outputs that are each amplified and phase shifted with a PA and phase shifter, respectively, before being radiated at each AiP element. Here again the transmit AiP 408 for an SMPA radar design is not limited to a single input and the multiple outputs may not have a one-one correspondence to each transmit AiP element.

In designing SMPA radar systems, the configuration of AiPs or subarrays may be linear or non-linear, they may be in a single plane or in multiple planes, they may be equally spaced or variously spaced, they may be symmetric, uniform, non-uniform, or geometric in layout. The goal is to achieve the desired results of focus and control of the radar beam, increased FOV, reduced scan time, reduced processing time and reduced hardware, weight, and costs. The system may position receive antenna arrays in various configurations to focus the beam, expand the FOV, avoid redundancy, reduce data processing, and improve the accuracy of the radar system.

The AiPs or subarrays may be implemented in a radar unit, which is designed for imaging or to detect objects in the FOV of the vehicle. The receive and transmit AiPs are sized and positioned to meet specifications for the desired applications. In some examples of automotive or ariel applications, the radar unit is a front facing unit having a broad FOV in front of the vehicle. In other examples, the radar unit is positioned on a corner of the vehicle and requires a narrower FOV. The goal is to provide as much coverage for a vehicle as realizable with AiP configurations.

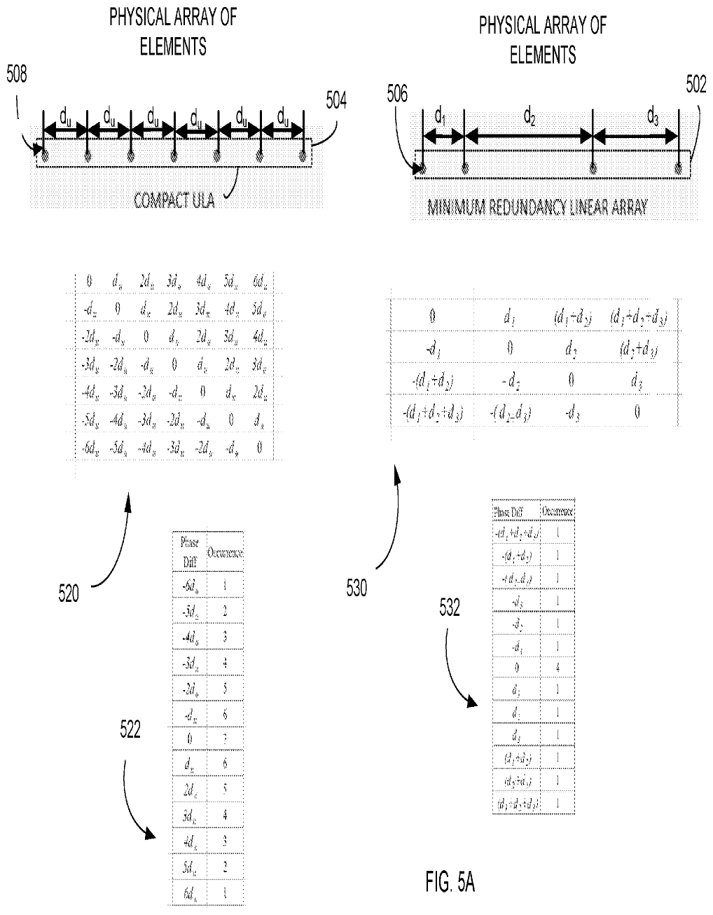

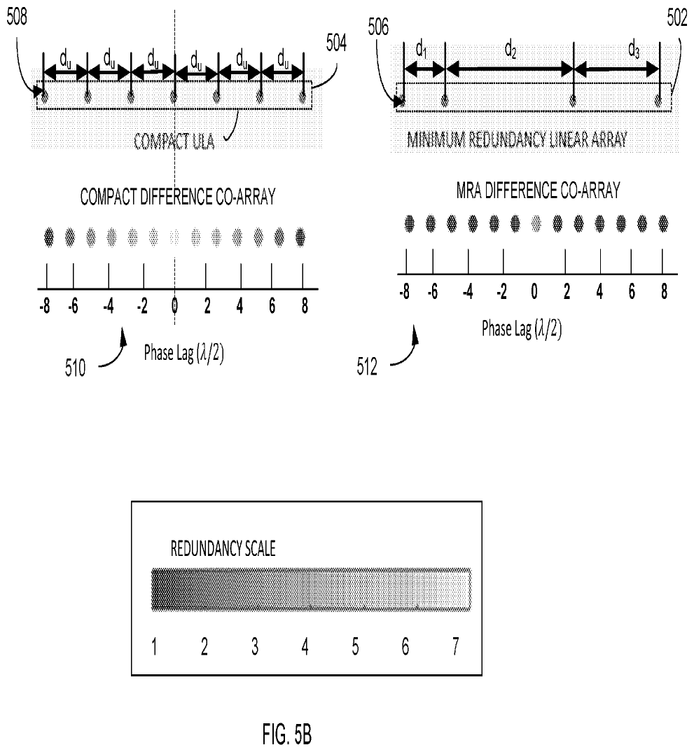

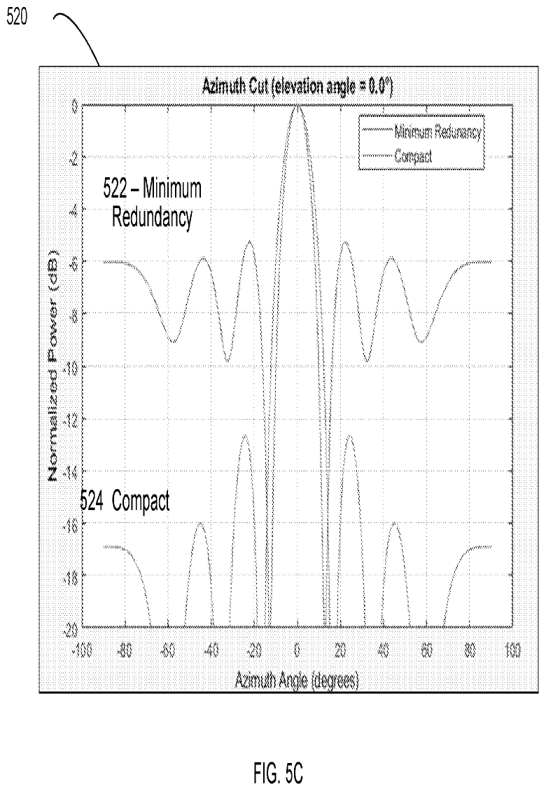

Before presenting the design steps for the 2D sparse array aspects of the invention, sparse linear arrays (SLAs) and uniform linear arrays (ULAs) are briefly compared in FIGS. 5A,5B, and 5C to provide context for the SMPA radars. FIGS. 5A, 5B and 5C illustrate example arrays formed to reduce redundancy of radiating elements and to reduce the computational burden. The array designs based on compact uniform linear array (ULA) and minimum redundancy array (MRA) sparse array features as well as the associated array responses.

A ULA is a set of sensor elements equally spaced along a straight line and the design may be used to improve signal-to-noise ratio (SNR) of the transmitted signal and gain in a given direction. SLAs have non-uniform spacing between elements and are used to reduce the phase-lag redundancy between array elements and to reduce the computational burden. The array designs compared in FIG. 5 are based on a compact uniform linear array (ULA) and a Minimum Redundancy Array (MRA) sparse array with the same aperture size as the ULA. The compact array 504 is a ULA with half-wavelength (λ/2) spacing between each element 508. The MRA 502 has element 506 spaced at non-uniform spacings between elements. The compact ULA 504 with λ/2 spacing between 7 elements 508 is shown along with MRA 502 with 4 elements 506. While for a compact array λ/2 spacing may be chosen to satisfy the Nyquist sampling criteria, the MRA has only one pair of elements 506 with λ/2 spacing while the remaining pairs have larger multiples of λ/2. The difference co-array is determined by the spacings between all element pairs in the array. The difference co-array 510 corresponding to the compact ULA and difference co-array 512 corresponding to the MRA each have spacings between elements with maximum phase lags between elements of +3λ with no missing half-wavelength spacing differences or phase lags. Without missing phase lags and the same maximum phase lag, the MRA 502 can have a comparable angular resolution to the compact array 504. For the compact difference co-array 510, there are multiple phase lags that are the same while the MRA difference co-array 512 minimizes the redundancy of phase lags except for the zero-phase lag. Consequently, from the point of the corresponding difference co-arrays 510, the compact array 504 contains a large amount of signal sampling redundancy that is not present in the MRA 504.

As motivation for the use of sparse arrays for the SPMA radar, the array responses 520 of the compact array and MRA beams are shown when they are both steered to 0 degrees. The MRA pattern 522 has a comparable beamwidth to the compact array pattern 524 implying comparable angular resolution as should be expected for arrays with the same aperture length. Consequently, the sparse array features of an SPMA radar should not limit the achievable angular resolution.

Further inspection of the compact array and MRA array responses 520 indicates that while the beamwidths are comparable the SLL of the MRA pattern 522 are significantly poorer than the compact array pattern 524. These poorer SLLs of the MRA, however, does not imply that a SMPA radar will also have poor SLL. With the appropriate signal processing as is shown below, the SPMA radar can achieve good sidelobe performance.

Another important factor that impacts sidelobe level perform is the amount of phase-lag redundancy present in the array. To increase the phase-lag redundancy and lower the SLL of an array aperture, one also considers non-redundant arrays (NRAs) which are similar to MRAs. The difference being that the NRAs may have redundancies at non-zero phase lags. Generally, an NRA attempts to approach the ideal MRA with a minimal number of phase lag redundancies while reducing the number of array elements compared to a compact array. NRAs would also be expected to achieve a better SLL than the MRA given the additional phase lag redundancies. Improving SLL by adding redundant phase lags will be an important consideration for the MIMO aspects of the SMPA radar design.

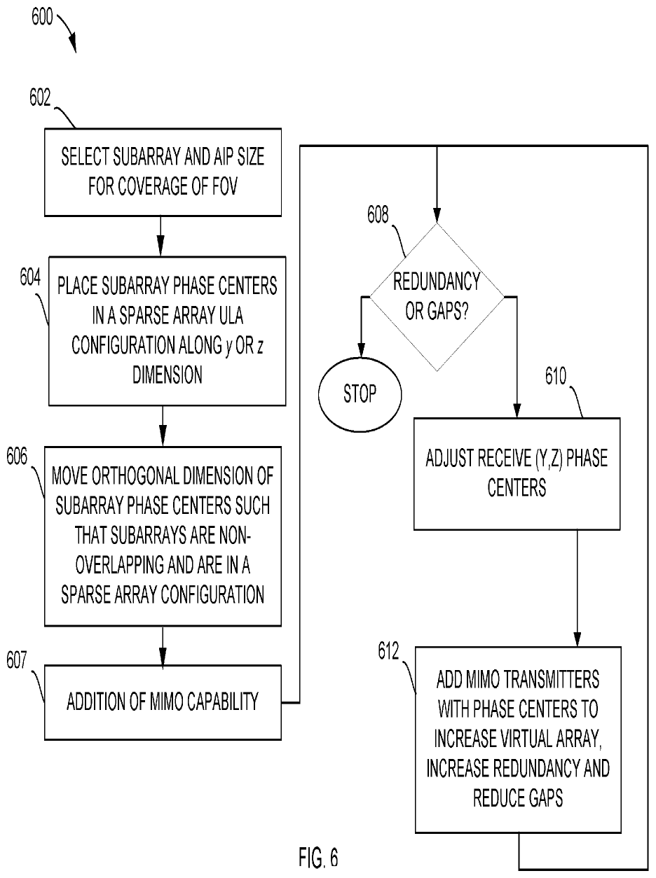

FIG. 6 illustrates a process for designing an SPMA radar as in FIG. 4 and in following examples with various MIMO aspects for 2-D Angle of Arrival (AoA) target location detection, according to example embodiments of the present inventions and subject technology. The flow chart 600 shows the steps for generating, and in some examples, optimizing the sparse array and incorporating MIMO features of an SMPA radar design with 2-D Angle of Arrival (AoA) capability. The radar system implementing an SMPA receive and transmit antenna is designed to scan a FoV having a desired area or volume. The specifications of the SPMA receive and transmit antenna are a function of the FoV dimensions and desired angular resolution. The process 600 includes selecting an aperture size, a subarray size, and configuration of subarrays and AiP structure. The following description is done by a first dimension and then another. In this example, the process starts with the y-dimension, although one could exchange the coordinates and start with the z-dimension first. First, the process selects the type of subarray, 602, to cover the FoV as discussed for FIG. 2. Selection of the subarray type and AiP correspond to the aperture size. The next step 604 involves choosing an NRA or other sparse array configuration for the physical AiPs or subarrays in the y-dimension and positioning the subarrays to have the desired phase centers. This step places the phase centers in a sparse array ULA configuration along y-dimension. At this point, the subarrays may physically overlap. The physical overlap of AiPs is removed in the next step 606 where an NRA is selected in the orthogonal z-dimension while the initial y-dimension of the phase centers remain unchanged. This process moves the subarray phase centers in the orthogonal dimension such that subarrays are non-overlapping and are in a sparse array configuration. The goal is to position the elements of the receive antenna array to have a variety of phase lags or shifts with minimal redundancy. The process determines if there are redundancies or gaps in the phase-lags as is discussed in later examples of SMPA radars. For the next step 608, if there is sufficient redundancy, minimal phase-lag gaps and if desired MIMO features were added in 612, processing stops and the SMPA is complete; else the process adjusts the subarray phase-center locations, 610, which are further optimized for aperture size, phase-lag redundancy, and to minimize the phase-lag gaps.

Continuing with process 600, when the MIMO configuration for the SMPA is being included, step 612, the N MIMO transmit (Tx) AiPs are placed at the appropriate phase centers to achieve the desired virtual array aperture size and to increase the phase-lag redundancy. The physical aperture size may be increased up to N times when the Tx AiP are placed at integer multiples greater of the receive antenna dimensions. To improve SLL performance and minimize phase-lag gaps in the prior step, the Tx AiPs are placed at fractional values or fractional plus integer values of the physical receive subarray dimensions. Steps 610 and 612 as indicated in process 600 may be iterated until acceptable 2-D angular resolution and side-lobe level (SLL) performance is achieved. While the flow chart in FIG. 6 is specifically for planar arrays in the y-z plane, an extension of procedure for AiPs or subarrays on a non-planar surface or 3-D volume is straight forward.

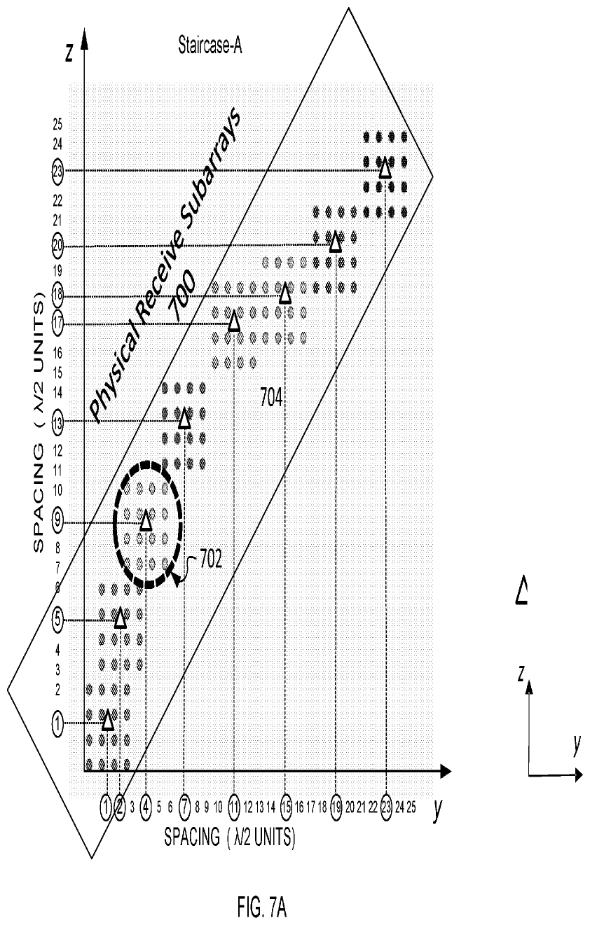

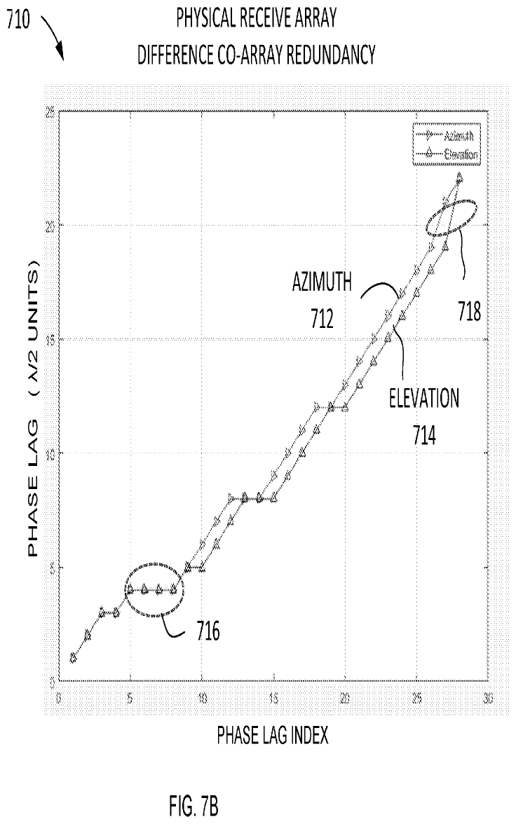

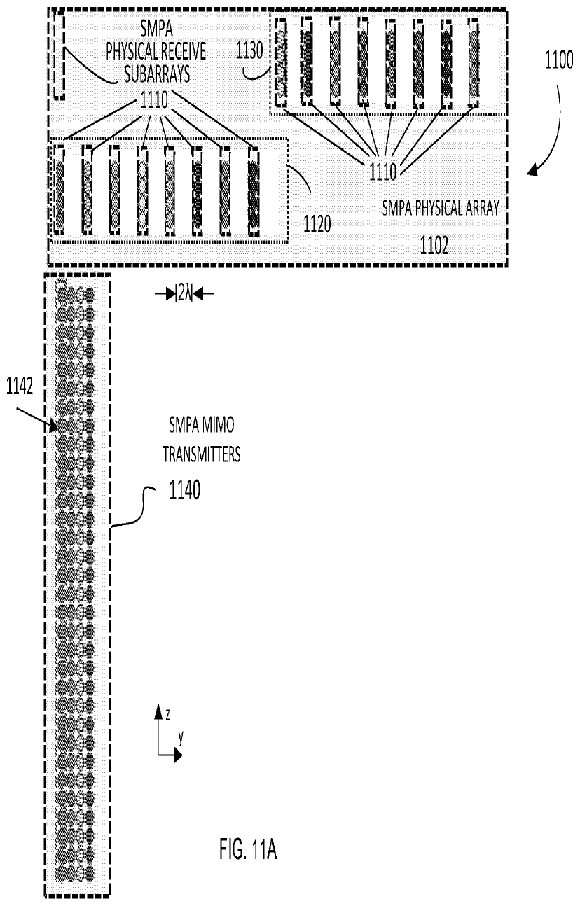

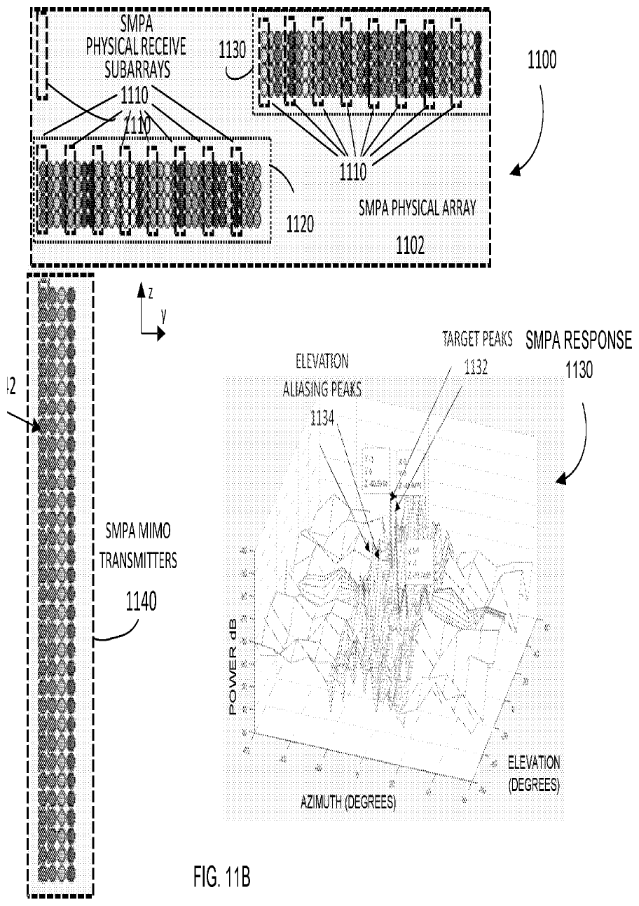

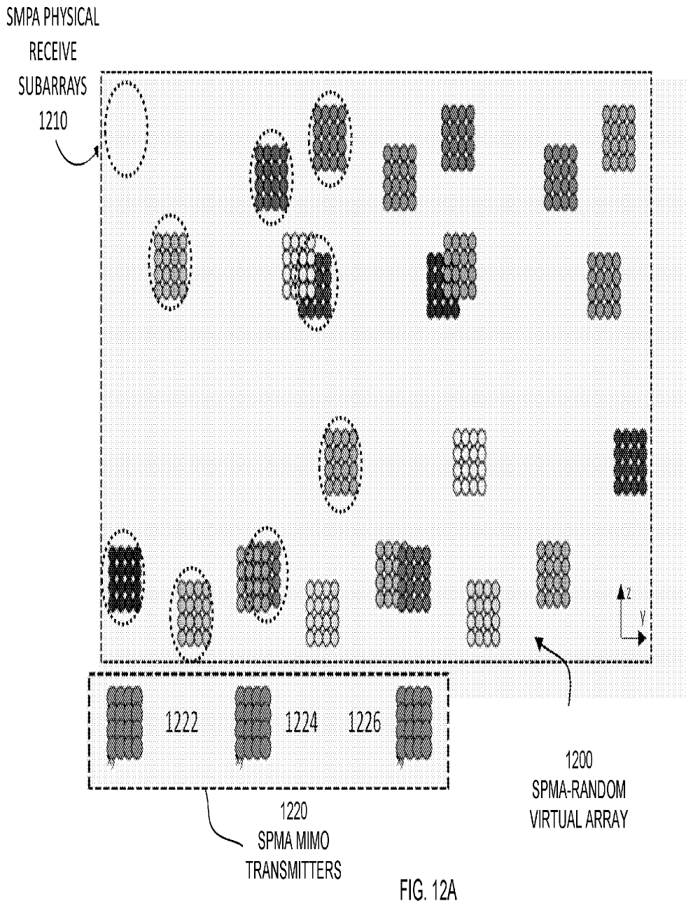

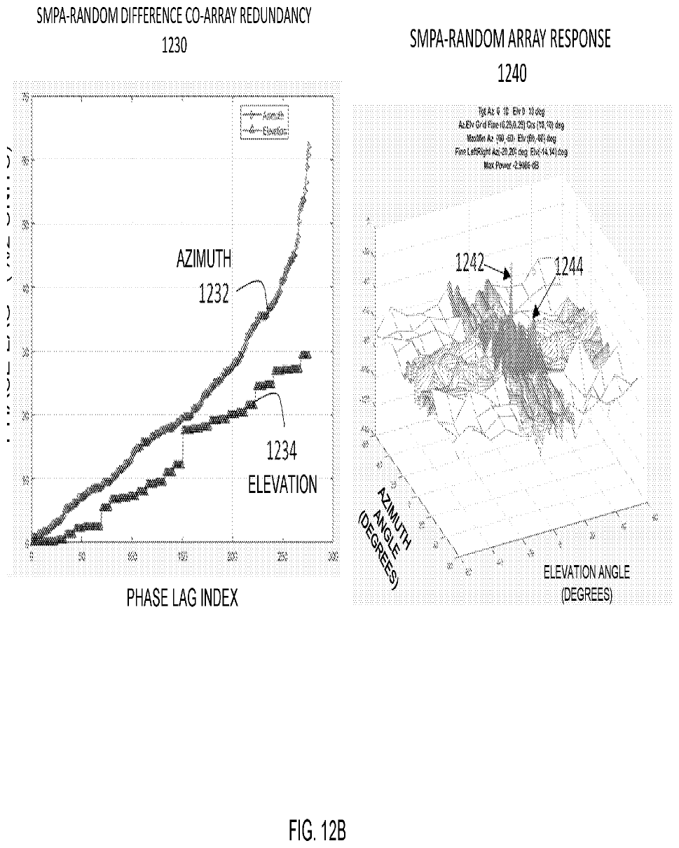

Several examples of possible SMPAs using the above combination of subarrays, sparse arrays and MIMO configurations follow. In FIGS. 7-10, several staircase subarray patterns are shown. In FIG. 11, a sparse array pattern with an interleaved MIMO design and focused beam in elevation with monopulse AoA capability is shown. In FIG. 12, it is shown that the SMPA is not limited to a specific sparse array pattern but may also be designed with a random selection of subarray phase centers. This random pattern may achieve reasonable 2-D angular resolution performance which further demonstrates the flexibility and diversity of the invention.

FIGS. 7A and 7B illustrate an example of a staircase configuration sparse array, referred to herein as “Staircase A,” and the phase-lag redundancy, according to example embodiments of the present inventions and subject technology. The first SMPA Staircase-A No-MIMO pattern 700 in FIG. 7A includes (4×4) subarrays, such as subarray 702, in a sparse configuration. In this example, the subarrays are implemented as AiPs. In the y-dimension, the phase centers are chosen for an NRA pattern with positions 1, 2, 4, 7, 11, 15, 19, 23 separated by units of λ/2. The positions are identified by triangular markers, such as marker 704. The phase differences between phase centers may be referred to as the phase lag, phase difference or phase shift. For the orthogonal z-dimension, a similar non-redundant array with positions of 1, 5, 9, 13, 17, 18, 20, 23 was chosen. For the z-dimension, the difference co-array is essentially reversed from the y-dimension to prevent the physical overlap of the AiPs 702. The difference co-array phase-lags 710 of FIG. 7B are illustrated for the azimuth by the plot 712 and for the elevation by the plot 714, each corresponding to AoA. The length of the horizontal line segment 716, corresponding to a given phase lag, indicates the redundancy or the number of times the phase lag occurs for the sparse array. The x-axis of 710 is the index of a phase lag after the phase lags have been sorted in ascending order. Phase-lag gaps 718, occur when there are no phase center difference that result in a phase lag between existing phase lags. For the azimuth plot 712 and elevation plot 714 there is a single gap greater than λ/2 which allows lower side lobe levels to be achieved with the advanced signal processing detailed later. When additional phase-lag gaps are present, the SLL performance is degraded.

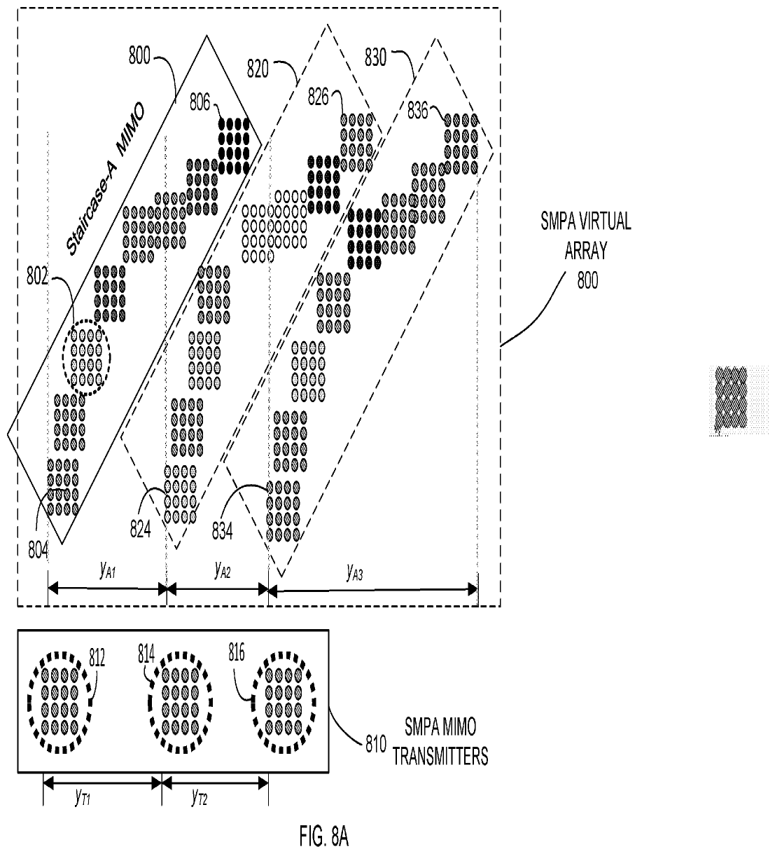

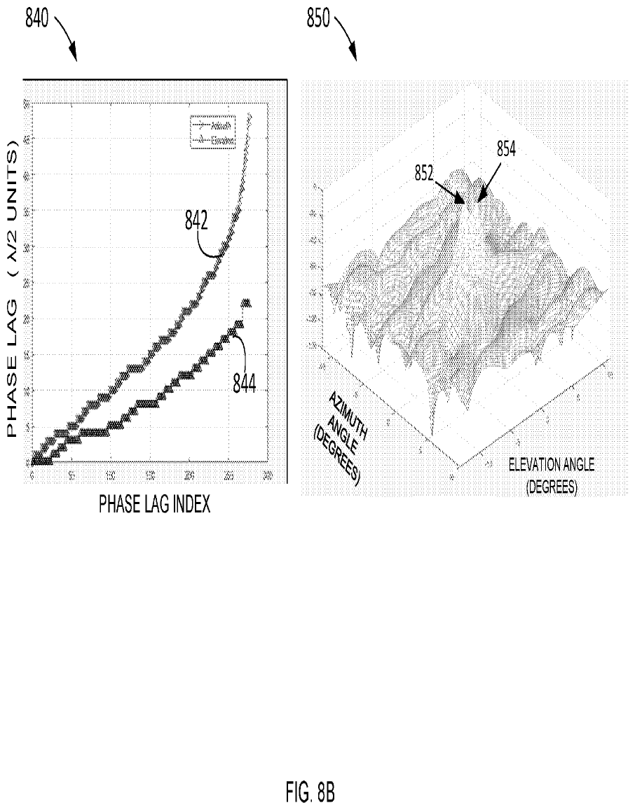

FIGS. 8A and 8B illustrate an example of an SMPA radar based on a Staircase-A configuration having MIMO design aspects. FIGS. 8A and 8B illustrate an example of an SPMA radar in a staircase sparse array configuration having MIMO design aspects, wherein the SPMA radar is based on a Staircase-A configuration to form a virtual array, the virtual array having a physical Staircase-A array positioned proximate multiple transmit arrays and multiple virtual arrays, wherein the system operates as having an enhanced receive aperture for improved azimuth resolution along with plots of the array response.

The SMPA virtual array has a physical Staircase A array positioned proximate multiple transmit arrays and multiple virtual arrays, wherein the system operates as having an enhanced receive aperture for improved azimuth resolution along with plots of the resultant responses, according to example embodiments of the present inventions and subject technology. FIG. 8A illustrates the SMPA radar with a Staircase-A MIMO-A design where the MIMO features have been added to the Staircase-A sparse array similar to array 700 having configuration as in FIG. 7A. The distance in the y-direction between array 802 and virtual array 820 is y_{A1}; the distance between arrays 820 and 830 is y_{A2}; and the distance across the array 830 is y_{A3}. These distances are measured with respect to phase centers of the arrays 802, 820, 830. The first distance y_{A1} is from the phase center of AiP 804 to the phase center of AiP 824. Note that the phase center of AiP 806 in this embodiment is aligned in the z-direction with AiP 824; similarly, the phase center of AiP 826 is aligned with the phase center of AiP 834. The second distance y_{A2} is from the phase center of AiP 824 to the phase center of AiP 834. The aperture in the y-dimension of the receive antenna array, SMPA virtual array 800, is the sum of y_{A1}, y_{A2}, y_{A3} plus the y-dimension of an AiP. The transmitter antenna, SMPA MIMO transmitters 810, includes Tx AiPs spaced as a function of the array size dimensions in the y-dimension from the Tx AiP 812 in the y-dimension by half times AiP 814 and one times AiP 816 the physical receive size y_{A1}. The effect is improved azimuth resolution due to the doubling of the azimuth virtual array aperture size with the virtual arrays 820 and 830. SLL performance is also improved with the sub-multiple placement of the Tx AiP 814 in the y-dimension due to the resulting virtual array 820. FIG. 8B plots the difference co-array phase lags 840 which has increased azimuth phase-lag redundancy 842 and fewer phase-lag gaps compared to plot 712. The elevation phase lags 844 also show additional redundancy when compared to plot 714. With increased redundancy and fewer gaps, better SLL performance can be achieved with an SMPA radar.

An SMPA radar can angularly resolve closely space objects when the range and Doppler measurements are unable to. This makes the SMPA radar highly desirable for imaging as well as object detection applications. The array response 850 shows that two closely spaced objects separated only by their 2-D angles are resolved as indicated by the peaks 852 and 854. The peaks agree well with the true object positions indicated by the diamonds. The array response 850 also shows low SLLs is achieved for this SMPA radar.

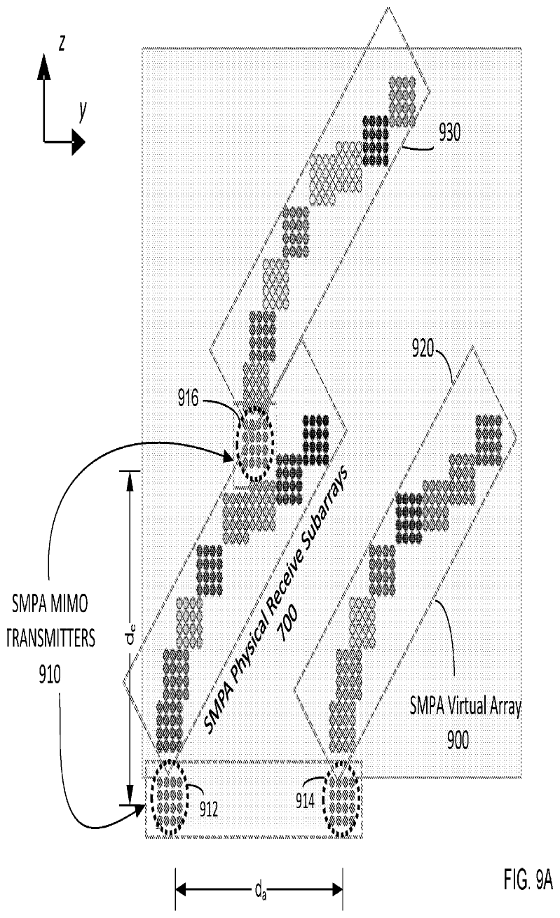

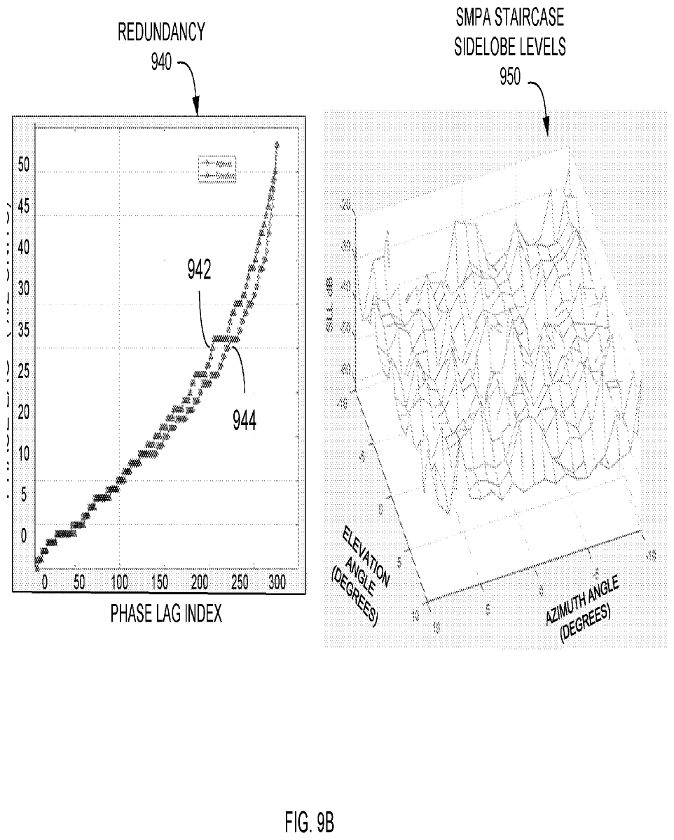

FIGS. 9A and 9B illustrate an example of an SPMA radar in a Staircase-A configuration with multiple transmit arrays distributed in azimuth and elevation to provide corresponding virtual arrays for improved azimuth and elevation resolution and plots of the resultant responses, according to example embodiments of the present inventions and subject technology. An SMPA radar Staircase-A MIMO-B design 900 with improved azimuth and elevation resolution compared to the SMPA Staircase-A No-MIMO design 700 of FIG. 7 illustrates the flexibility of the technology wherein SMPA 900 doubles the aperture, physical size in the z-dimension by separating the Tx AiP 916 from Tx AiPs 912 and 914 in the z-dimension by one-times the physical receive elevation size, de. Similarly, the aperture is doubled in the y-dimension by separating Tx AiPs 912 and 914 by one-times the SMPA physical receive azimuth size, dₐ. With the SMPA virtual arrays 920 and 930, both the azimuth and elevation resolutions are improved by a factor of 2. In FIG. 9B, the difference co-array phase lags 940 shows both the azimuth 942 and elevation 944 redundancies are comparable. Plot 950 shows the peak side lobe level (PSLL) for a target placed throughout the FoV for the SMPA radar configuration in FIG. 9A. The PSLL response 950 shows that peak sidelobes can be below 25 dB which allows better resolution of weak return signals from targets that are located close to other targets having strong return signal, radar echo.

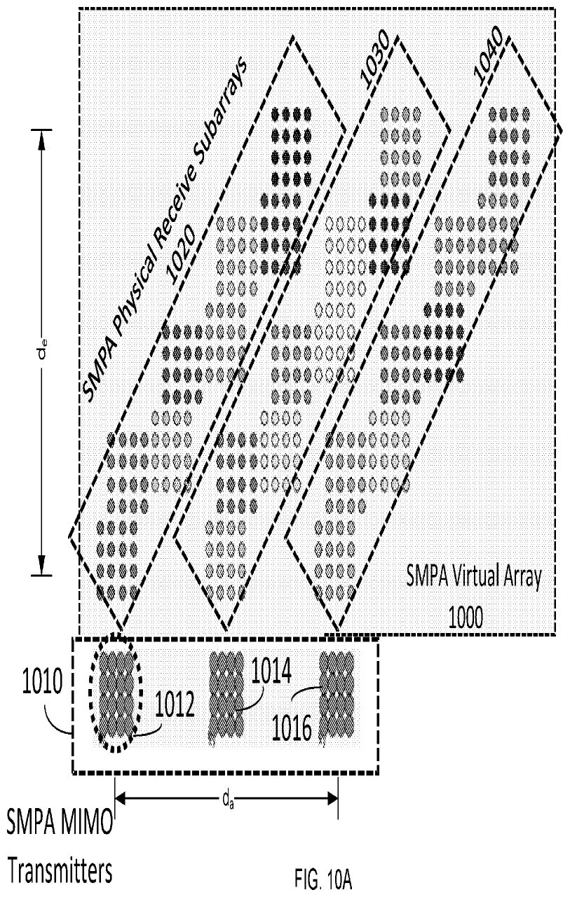

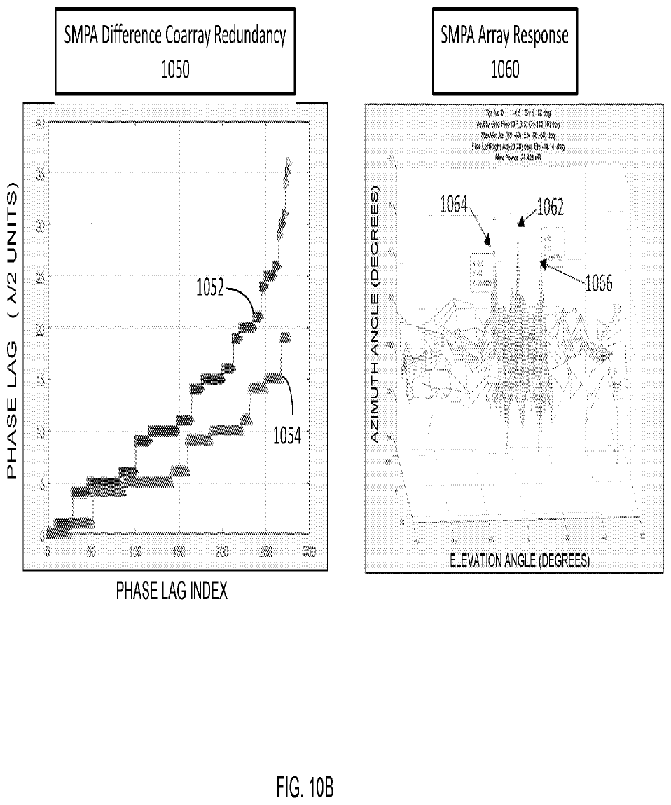

FIGS. 10A and 10B illustrate examples of the SPMA radar in a Staircase-B configuration with multiple transmit arrays uniformly spaced and plots illustrating the resultant impact on the angular sidelobes and object detections, according to example embodiments of the present inventions. FIG. 10A illustrates the SMPA radar Staircase-B MIMO-A design 1000. The Staircase-B pattern is based on an NRA that contains more phase-lag gaps than the Staircase-A pattern. The choice of on an NRA with more gaps will depend on the tolerance of the radar application to the higher sidelobes. Following the design process of FIG. 6, the y and z-dimension NRA phase centers of the 8 physical receive AiPs 1020 were chosen by offsetting AiPs by λ/2 between successive subarrays while also alternating between the y and z dimensions. The Tx AiPs 1010 are separated by one-half times the azimuth aperture, dₐ, where the distance from AIP 1012 to AIP 1014 is (λ/2)*dₐ and the distance from AIP 1012 to AIP 1016 is dₐ . . . . The resulting SMPA virtual arrays 1030 and 1040 correspond to the placement of the Tx AiP 1014 and Tx AiP 1016 respectively. FIG. 10B illustrates the difference co-array phase lags. Plot 1050 has several phase-lag gaps (e.g. 1056 and 1058) in the azimuth 1052 and elevation 1054 dimensions. While the NRA choice for the Staircase-B pattern would be expected to improve the angular resolution slightly with a larger aperture, the resulting phase-lag gaps illustrated in plots 1052 and 1054 degrade the SLL performance as illustrated in plot 1060. The AoAs of two targets are accurately determined from the peaks 1062 and 1064. Also present is a high side-lobe 1066 that could be mistaken for a target unless additional prevention features are implemented such as preventing the Tx illumination of this high sidelobe location.

As mentioned previously, the invention is not limited to the (4×4) AiPs subarrays examples discussed above. FIGS. 11A and 11B illustrate an example of an SPMA radar incorporating ULA subarrays proximate a transmit array, and plots of the array response for detection of targets clustered close together, according to example embodiments of the present inventions and subject technology. FIG. 11A illustrates an SMPA radar design 1100 in an Elevation Monopulse configuration. The radar configuration and design 1100 uses ULA subarrays with the length along the z-axis. This choice allows a wide azimuth FoV (e.g.,)±60° while focusing the subarray beam in elevation. To cover the desired elevation FoV (e.g.,)±20°, the subarray phase shifters (not shown) steer the elevation beam with the appropriate angle step sizes. The specified sizes of the ULAs below are examples which would ultimately be influenced by the SMPA radar design goals. The receive antenna array 1120 of configuration 1100 are positioned lengthwise along the y-dimension, the receive antenna array 1120 is made up of subarrays 1110. The physical receive antenna array 1120 employs (4×1) AiPs 1110, which are separated by 21 in the y-dimension. Half of the physical receive antennas 1120 are separated and offset from the other half 1130 in the z-dimension, as illustrated, which allows the elevation AoA estimate of the targets. FIG. 11B illustrates the configuration 1100 with virtual subarrays sandwiched between the physical subarrays 1110.

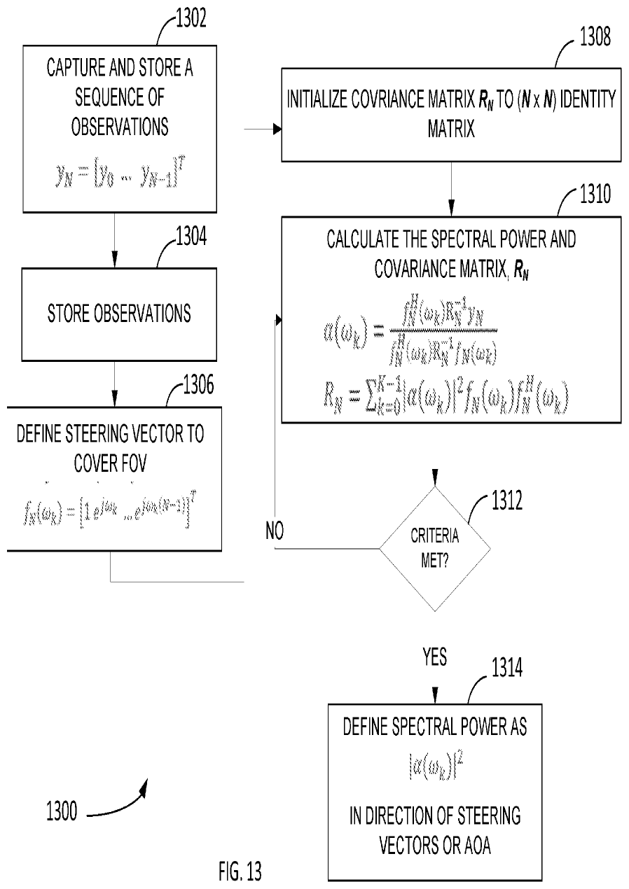

The SPMA MIMO transmit antenna is configured lengthwise along the z-dimension. The Tx AiPs 1140 consists of 4 Tx AiPs or subarrays arranged in (32×1) columns 1142. The λ/2 spacing in the y-dimension between the Tx AiPs 1142; in the present embodiment, is designed for operation with the receive antenna arrays 1100. When a MIMO orthogonal waveform is used, the radar antenna array configuration 1100 results in the SMPA virtual array 1102. The 2λ spacing along the y-dimension of the physical receive arrays in 1120 and 1130 is filled in by the Tx AiPs 1142. To determine an AoA of a target, the azimuth is determined by the virtual array phase centers along the y-dimension while elevation is determined in a monopulse-like fashion along the z-dimension. The difficulty is that the azimuth and elevation are coupled since the virtual array halves corresponding to physical subarrays 1120 and 1130 are offset along the y-dimension. Consequently, advanced signal processing such as IAA detailed in FIG. 13 or Compressive Sensing techniques are used to solve for both the azimuth and elevation AoA at once. The accuracy of the elevation estimate is determined by the phase-center distance in the z-dimension between 1120 and 1130. FIG. 13 illustrates an Iterative Adaptive Algorithm (IAA) method to process radar signals received by an SMPA as described herein, according to example embodiments of the present inventions and subject technology (Sandy this seems redundant here?). Using IAA as detailed in FIG. 13, the SMPA response resolves the two target signals 1132. Elevation aliasing 1134 of the targets occurs since there are only 2 phase centers in the z-dimension and their spacing is substantially larger than λ/2 for minimum Nyquist sampling of the signals to prevent aliasing. The aliasing 1134 would not be identified as a target since it is outside the steered elevation beam of the Tx AiPs 1140. Guard channels for elevation could also be added to a system to prevent detections that are illuminated by the Tx AiPs 1140 elevation side-lobes. To provide additional sidelobe protection, the receive subarrays could use a larger ULA subarray (e.g., 16×1 instead of 4×1) that is steered in elevation with the Tx and providing lower two-way PSLL. Also, one should note that while the transmit antennas were presented as 4 Tx AiPs with (32×1), these subarrays could also be implemented with eight (4×4) Tx AiPs that are stacked in a column along the z-dimension. The (32×1) Tx subarrays would be realized by controlling the phase shifters and PAs across the (4×4) AiPs to obtain the (32×1) column behavior.

An SMPA radar design has a great deal of flexibility in the placement of AiPs or subarrays and is not limited to the use of the staircase and ULA patterns presented. Good performance can also be achieved with non-specific patterns. In some embodiments, a randomly chosen array gives reasonably good performance as illustrated in FIG. 12A. FIGS. 12A and 12B illustrate an example of an SPMA radar with random placement of the subarrays and plots of the resultant phase-lag redundancy and of the antenna response for detection of closely spaced targets, according to example embodiments of the present inventions and subject technology. Here, the (4×4) subarray (y,z) phase centers were randomly chosen such that the physical subarrays/AiPs 1210 do not overlap. The virtual array 1200 is formed with 3 Tx (4×4) AiPs placed along the y axis in a similar fashion to the previous MIMO-A placements. The difference co-array phase-lags 1230, shows a single gap in the azimuth 1232 and a few gaps in the elevation dimension 1234 so one expects that the array response will have higher sidelobes in the array response for some target locations. The array response for two targets 1232 and 1234 are clearly identifiable above the sidelobes.

Another important aspect of the inventions is the sparse-MIMO placement of the subarrays/AiPs are the advanced signal processing algorithms to reconstruct the signal that an equivalently sized full array would have received so that the 2-D angular resolution and accuracy performance can be recovered. The classical Delay and Sum (DAS) algorithm for determining the AoA is not suited for sparse array signals and leads to poor performance with very high sidelobes. A large degree of phase-lag redundancy is required in the difference co-array for the DAS algorithm to achieve the low sidelobes with an appropriate weighting window. As stated previously, the SMPA sparse and MIMO array features have greatly reduced the hardware complexity but also it is worth emphasizing that the with the substantial reduction of the number of phase centers, the digital signal processing data load is also greatly reduced.

Advanced signal processing options for sparse array signals include various Compressive Sensing algorithms and IAA. Compressive Sensing algorithms can reconstruct the sparse array signal that have minimal redundancy of the difference co-array phase-lags. A strength of these algorithms is that the signal reconstruction can be done with a single snapshot of data which is an important feature for object detection and imaging radars where the target scene can change quickly. These algorithms include Orthogonal Matching Pursuit (OMP), Basis Pursuit Denoising (BPDN), Alternating Direction Method of Multipliers (ADDM), to name a few as well as others that may be developed in the future. The basic approach of CS algorithms for sparse arrays is to first define a dictionary of steering vectors that covers the FoV to the desired granularity of potential target locations. One then searches through the dictionary for the combination of steering vectors that best fit the array signal data. For example, the BPDN best estimate of the steering vector combinations s for a sparse array data set of Y is obtained by optimizing the following criteria

$$\hat{s} = arg {min}_{s} {‖ s ‖}_{1} ; subject to \frac{1}{2} {‖ Y - Θ s ‖}_{2} < ϵ$$

where s is a vector that contains the amplitude of each dictionary steering vector, θ is a matrix that contains the dictionary steering vectors, e is a small value, and ∥ ∥₁ and ∥ ∥₂ are the l₁ and l₂ norms respectively. Some challenges for using CS techniques for an SMPA radar system include reducing computation time for real-time system operation, choosing an appropriate value for parameters such as, and the estimate accuracies for target locations that are in between steering vectors or grid points.

The Iterative Adaptive Algorithm appears to be a better choice than CS algorithms for determining the 2-D AoA of an SMPA radar system. The algorithm is a non-parametric iterative algorithm based on a weighted least squares for target localization. IAA requires a single snapshot as does CS, resolves close targets relative to the sparse array aperture size, is more robust than CS for off-grid target locations, provides low SLLs as discussed above for SMPA radar systems, and converges after a few iterations. While the algorithm requires less computation time than the CS algorithms mentioned above, computation time is significant and requires sufficient processing capability for real-time applications. There are also implementations of IAA that can reduce the computation time by an order of magnitude or more by taking advantage of the Hermitian and Toeplitz properties of the covariance matrix.

FIG. 13 illustrates an iterative adaptive algorithm (IAA) for determining an AoA for the SMPA. The process 1300 captures and stores a sequence of observations in the first steps, 1302, 1304. The steering vectors or spatial frequency vectors f_{N}(ωₖ) are defined to cover the FoV of the SMPA radar with the desired granularity where N is the number of virtual phase centers in the SMPA radar and 0≤k≤K−1 where K is the number of steering vectors, 1306. The process initializes the covariance matrix R_{N} to the N×N identiy matrix, 1308. The formulas to calculate spectral power |α(ωₖ)|² of each steering vector f_{N}(ωₖ) and covariance matrix, R_{N}, are given, 1310. When the stopping criteria is met 1312, the process defines spectral power in the direction of steering function to cover FoV, 1314. Else the process returns to step 1310. The 2-D AoA is then determined by finding the peaks of the spectral power or array response |α(ωₖ)|².

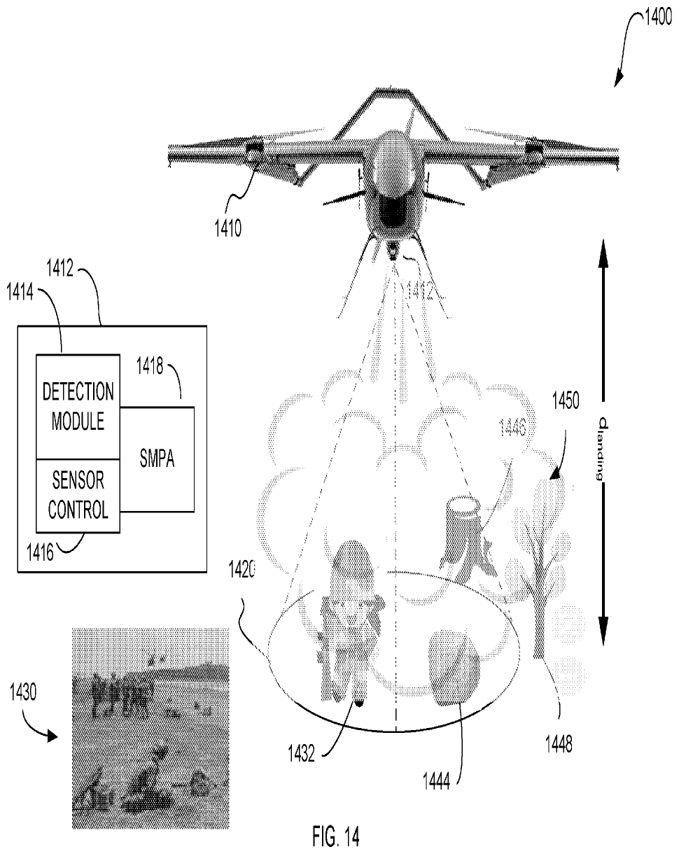

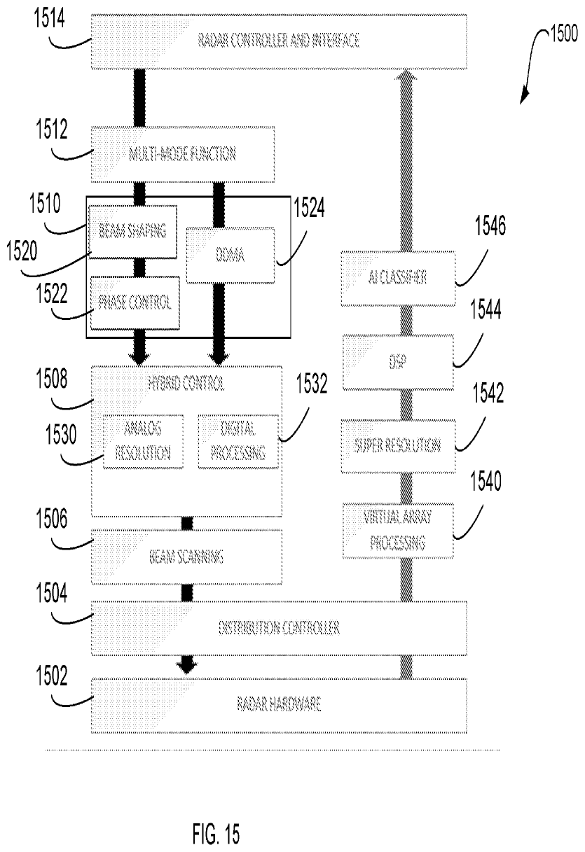

FIG. 14 illustrates an aerial application for use of an antenna array using an SMPA radar, according to example embodiments of the present inventions and subject technology. An aircraft 1400 includes radar modules 1410, 1412, each having a specified FOV, range and aperture. In the case of radar module 1410, an SMPA would provide imaging capability of the FoV to ensure safe Vertical Take-Off and Landing (VTOL). Similarly, for a forward-looking radar module 1412, the imaging and object detection capability of an SMPA radar could provide avoidance of other aircraft, delivery drones, building structures and other obstructions. The radar module 1412 is further detailed having sensor control 1416 coupled to SMPA radar 1418. Received information from object detections is processed by detection module 1414. The radar module 1412 has a FoV 1420. The operational architecture of a radar module employing an SMPA radar, and the methods and apparatuses of the inventions described herein are illustrated in FIG. 15.

In landing operation, the aircraft 1400, such as a helicopter, plane, UAV, drone and so forth, requires a detailed understanding of the landing area FoV 1420. The aerial vehicle may land on non-conventional surfaces as well as on landing strip and prepared or known landing areas. Additionally, there may be a variety of obstacles that may impact the landing. There are two radar units 1410, 1412 illustrated on aerial vehicle 1400. The FoV 1420 of the radar unit 1412 is the area within which objects are to be detected. For example, trunks 1446, trees and bushes 1448, people 1432, rocks 1444 and so forth. In military settings, such as scene 1430, the soldiers are moving and close together, requiring the radar to operate rapidly to respond. In addition, on landing the aerial vehicle 1400 often stirs up dust 1450 which interferes with visibility in the landing area.

Continuing with FIG. 14, the radar unit 1412 includes a detection module 1414, sensor control 1416 and SMPA radar 1418. Sensor control 1416 includes beamforming and beamsteering controls for the arrays of SMPA 1418. The sensor control also controls and configures the transmission signals of the various radiating elements according to desired aperture of the receive array. The sensor control 1416 and the SMPA 1418 create a virtual array having a larger aperture than the physical receive array of SMPA 1418. The detection module 1414 responds to received signals to classify and/or identify the detected object. This hybrid radar unit 1412 incorporates analog beam steering by phase control and digital processing of received signals. The virtual array may take a variety of forms. In some embodiments, the sensor control 1416 directs signals to subsets of the full physical receive arrays to adjust the aperture.

FIG. 15 illustrates a radar architecture incorporating SMPA techniques, according to example embodiments of the present inventions and subject technology. The radar system 1500 includes a radar controller and interface module 1514 providing control of transmit operation, interpretation of received information and interface to outside the system 1500, wherein module 1514 is coupled to multi-mode function module 1512. The electromagnetic control module 1510 includes a beam shaping module 1520, phase control module 1522 and modulation module, DDMA 1524. The electromagnetic control module 1510 is coupled to hybrid control modules 1508, having analog resolution module 1530 and digital processing module 1532. The system 1500 also includes a radar hardware portion 1502 coupled to a distribution controller, 1504. Radar hardware includes transmit and receive antenna array configurations, which in the present inventions implement SMPA and MIMO. Received signals are processed through virtual array processing modules 1540, super resolution module 1542, digital signal processing (DSP) unit 1544, and an AI classifier module 1546.

An imaging and object detection radar module according to an example embodiment, referred to as an SPMA radar, includes a transceiver adapted to generate transmit signals to a transmit antenna array, the array arranged as multiple subarrays, each adapted to transmit electromagnetic signals having different transmission parameters. The radar having a receive antenna array made up of multiple subarrays configured in a sparse formation. The receive subarrays are configured in a stairstep type pattern, where the subarrays are sparse in orthogonal dimensions, to have no overlapping phase centers. Other embodiments may implement different shapes, formations, and configuration, such as a random arrangement. Arrangements may include subarray separations between phase centers that are multiple or sub-multiple of the receive antenna array aperture dimensions. Each subarray is made up of radiating elements organized into a shape. In the examples provided herein, the subarrays were in rectangular shapes, however, alternate embodiments may implement different shapes and configurations to separate the phase centers of the receive subarrays sufficiently to distinguish the transmit signals from each other by transmit parameters. There may be a uniform or a non-uniform spacing between subarrays. The configuration of receive antenna subarrays and the configuration of transmit antenna array, which may also be multiple subarrays, may be configured using a method to form linear NRAs or sparse arrays and used to optimize the sparse and MIMO configuration of subarrays to achieve optimal 2-D angle of arrival, phase-lag redundancy, phase-lag gaps, and sidelobe levels for the array response. The configuration chosen determines the abilities of the radar module. The sparse array techniques enable reduced receive processing by reducing redundancy of physical elements and transmitting distinct phase signals from each transmit subarray. This reduces the size and complexity of the radar module. These apparatuses and methods may be used in other applications as well.

In some embodiments, the receive subarray elements are coupled to analog components to modify received signals. This may include low noise amplifiers (LNAs) for signal amplification and phase shifters for beam steering. Transmit subarray elements are also coupled to analog components, such as in the transmission signal feed, wherein the signals are amplified by power amplifiers (PAs) and beam steered by phase shifters prior to transmission. The transmit antenna subarrays and the receive antenna subarrays may be positioned such that the radar module behaves as a sparse MIMO virtual array.

In some embodiments, a radar module has receive antenna subarrays packaged as an AiP having radiating elements, LNAs and phase shifters. Alternate embodiments may implement a variety of methods for beam steering. In some embodiments, the AiP has substrate material sandwiched between the antenna arrays on one side and the beam steering and control on the opposite side. The transmission signals may have modulations such as frequency modulated continuous wave (FMCW), time division multiple access, frequency division multiple access, orthogonal frequency multiple access, code division multiple access, Doppler division multiple access or other modulation protocol.

In some embodiments, a radar module includes a receive processing module adapted to receive transmission signals from the plurality of transmit antenna subarrays and adapted to distinguish the transmission signals as a function of transmission parameters. The receive processing module may employ signal processing with FFT or other algorithms to determine object range and Doppler velocity. The receive processing module may employ advanced sparse-array signal processing such as IAA or CS to determine the 2-D angle of arrival of objects for an SPMA radar module.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. An antenna system, comprising:
a plurality of transmit radiating elements for transmission of electromagnetic signals; and
a plurality of receive radiating elements for receiving electromagnetic signals;
wherein the antenna system is characterized in that:
the plurality of transmit radiating elements are arranged into separated transmit groupings;
the plurality of receive radiating elements are arranged into at least one receive grouping;
a controller coupled to the plurality of transmit and receive radiating elements for generating transmission signals for the transmit radiating elements, the controller adapted to generate signals for each of the separated transmit groupings with at least one phase difference between the separated transmit groupings; and
a receiver coupled to the receive radiating elements for processing received signals from the separated transmit groupings at least one receive grouping;
wherein processing distinguishes received signals from each of the transmit groupings.

2. The antenna system as in claim 1, wherein the radiating elements in the receive groupings, each receive grouping having a corresponding phase center, and
wherein the receive groupings are arranged in a sparse array format.

3. The antenna system as in claim 2, wherein the sparse array format increases a number of phase center differences between the receive groupings.

4. The antenna system as in claim 3, wherein the controller comprises a beam steering module to adjust phase centers of each of the transmit and receive groupings.

5. The antenna system as in claim 4, wherein the antenna system is encapsulated in an antenna in package form.

6. The antenna system as in claim 1, wherein the receive groupings are arranged in a stairstep-type pattern.

7. The antenna system as in claim 1, wherein the receive groupings function as a virtual array and the antenna system functions as a multiple input-multiple output (MIMO) system.

8. A method for configuring an antenna system, characterized in that:
generating a configuration of a plurality of antenna subarrays, in a sparse array format corresponding to a first field of view, the plurality of antenna subarrays having phase centers; and
if the configuration has redundant phase centers, readjusting the configuration;
wherein the plurality of antenna subarrays comprising receive subarrays and transmit subarrays.

9. The method as in claim 8, wherein generating a configuration further comprises:
positioning the receive subarrays in a uniform linear array format in a first dimension; and
repositioning at least one receive subarray in a second dimension, orthogonal to the first dimension, wherein after the repositioning of the at least one receive subarray in the second dimension, a final configuration a sparse array configuration in the first and second dimensions.

10. The method as in claim 9, wherein the final configuration the phase centers are distinct.

11. A radar module, comprising:
a transceiver;
wherein the radar module is characterized in that:
a sparse multiple input-multiple output (MIMO) physical array (SMPA) comprising a plurality of subarrays of receive radiating elements;
a transmit antenna array comprising a plurality of transmit subarrays of radiating elements;
a transceiver coupled to the transmit array and SMPA; and
a classification and imaging module coupled to the SMPA.

12. The radar module as in claim 11, wherein a transmit subarray configuration is according to a linear, non-redundant array to function with the SMPA for multi-dimensional radar object detection, classification and imaging.

13. The radar module as in claim 12, wherein the aperture of the radar module is larger than the aperture of the receive radiating elements.

14. The radar module as in claim 13, further comprising a beam forming controller coupled to the SMPA and the transmit antenna array.

15. The radar module as in claim 14, wherein beam forming controller is an analog controller, have a phase shifting component.

16. The radar module as in claim 11, wherein at least a portion of the radar module is encapsulated in an antenna in package apparatus.

17. The radar module as in claim 11, wherein the classification and imaging module comprises a receive processing module adapted to receive and distinguish transmission signals from as a function of transmission parameters.

18. The radar module as in claim 17, wherein the classification and imaging module comprises an object detection module for signal processing received signals to determine object range and Doppler velocity.

19. The radar module as in claim 17, wherein the classification and imaging radar module comprises a sparse-array signal processing module to determine a 2-D angle of arrival of objects, The radar module as in claim 11, wherein the plurality of subarrays of receive radiating elements are arranged in a stairstep format.
